(19) United States
(12) Patent Application Publication
(10) Pub. No.: US 2021/0316494 A1
(43) Pub. Date: Oct. 14, 2021

(54) METHOD FOR PRODUCING A COMPRESSED-GAS CONTAINER

(71) Applicant: AlzChem Trostberg GmbH, Trostberg (DE)

(72) Inventors: Dominik ZGELA, Truchtlaching (DE); Peter DIJKINK, Garching an der Alz (DE); Florian RITZINGER, Altenmarkt (DE); Maximilian HARTL, Marquartstein (DE)

(73) Assignee: AlzChem Trostberg GmbH, Trostberg (DE)

(21) Appl. No.: 17/271,175

(22) PCT Filed: Aug. 26, 2019
(86) PCT No.: PCT/EP2019/072664

§ 371 Date: Feb. 24, 2021

(30) Foreign Application Priority Data
Aug. 28, 2018 (DE) 10 2018 121 012.4

(51) Int. Cl. B29C 53/66; B29C 70/32; B29C 63/24; B29C 53/84; F17C 1/06

(52) U.S. Cl. CPC B29C 53/66; B29C 70/32; B29K 2063/00; B29C 53/845; F17C 1/06; B29C 63/24

(57) ABSTRACT

The invention relates to a method for producing a compressed-gas container, particularly a compressed-gas container for transporting and for storing liquid gases or natural gas.

The present invention relates to a method for producing a compressed-gas container, in particular a compressed-gas container for transporting and storing liquid gases or natural gas, and in particular for producing a type II or type III or type IV compressed-gas container.

Pressurised containers for transporting liquid, compressed gases, such as compressed natural gas, are split into different classes or divided into different types with respect to their approval as transport containers. What these types have in common is that the compressed-gas containers are cylindrical and have one or two more or less dome-shaped ends.

Type I compressed-gas containers comprise a hollow body which is made entirely of metal, usually aluminium or steel. This type I is inexpensive but, due to its materials and design, is heavy in comparison with other types of compressed-gas containers. These type I compressed-gas containers are widely used and are used, inter alia, for sea transport.

Type II compressed-gas containers comprise a thin, cylindrical central portion made of metal having dome-shaped ends, referred to as end domes, which are also made of metal. The cylindrical central portion between the end domes is reinforced with a composite sleeve, referred to as a composite. The composite cover generally consists of glass or carbon filaments impregnated with a polymer matrix. The end domes are not reinforced. In type II compressed-gas containers, the metal liner bears approximately 50% of the tension generated by the internal pressure of the transported gas. The remaining tension is absorbed by the composite.

Type III compressed-gas containers comprise a hollow body which is made entirely of metal, usually aluminium. In contrast to type II, this hollow body, also called a liner, is completely reinforced with a composite and is therefore also reinforced on the end domes. The tension in the type III containers is practically completely transferred to the composite sleeve. The liner itself only bears a small part of the load. In comparison with type I or type II compressed-gas containers, type III compressed-gas containers are significantly lighter, but due to their design they are much more expensive to purchase.

Type IV compressed-gas containers, like Type III compressed-gas containers, comprise a liner which is completely encased in a composite material. In contrast to type III compressed-gas containers, however, the liner consists of a thermoplastics material, for example polyethylene or polyamide, which is very gas-tight. In type IV compressed-gas containers, the composite material almost completely bears the tension generated by the internal pressure of the transported gas. Type IV compressed-gas containers are by far the lightest but also the most expensive of the compressed-gas containers described herein due to their design.

In addition to types I to IV compressed-gas containers, which are approved by the responsible authorities under these designations, there is a further type V compressed-gas container. This compressed-gas container comprises a new type of vessel structure made of a composite material which has different compositions in sublayers.

Type II, type III or type IV compressed-gas containers are widely used and the subject matter of patent literature. As an example, reference is made to the following documents: DE 101 56377 A1, DE 10 2015 016 699 A1, EP 2 857 428 A1, and WO 2013/083 172 A1. Furthermore, the international patent applications WO 2013/083 152 A1 and WO 2016/06639 A1 describe methods for producing type V compressed-gas containers.

There is currently a growing desire to produce type III and type IV compressed-gas containers having particularly large volumes and to implement the production of compressed-gas containers of this kind in a continuous process. These requirements place special demands on the manufacturing technology of the compressed-gas containers. In particular, more time is required for depositing the composite layer on the liner. In addition, a greater layer thickness of the composite material is required in order to absorb the pressures generated by the liquid gases on the container. Both the increased manufacturing time and the required layer thicknesses place high demands on the polymer matrix to be used. In addition, there is also the need to provide suitable production methods.

The object of the present invention is therefore that of providing a method for producing compressed-gas containers which can be used widely and can be used to produce compressed-gas containers which meet the high requirements with regard to mechanical safety. Furthermore, a method is intended to be provided which is suitable for producing large compressed-gas containers, in particular large type II, type III and type IV compressed-gas containers.

These objects are achieved according to the invention by a method according to claim 1. Thus, the object of the present invention is a method for producing a compressed-gas container which has a storage volume for a pressurised gas and a sleeve enclosing the storage volume, the sleeve comprising a liner in contact with the storage volume and, at least in regions, at least one second layer deposited on the liner, which method comprises the following method steps:
a) providing
   i) a liner,
   ii) a curable epoxy resin matrix, and
   iii) reinforcing fibres,
b) applying the curable epoxy resin matrix to the reinforcing fibres, the curable epoxy resin matrix having a temperature in the range of from 15 to 50° C.,
c) winding, laying or depositing the reinforcing fibres on the liner to form the second layer,
d) curing the second layer at a temperature in the range of from 70 to 140° C.; wherein the curable epoxy resin matrix has a viscosity in the range of from 200 to 1000 mPa·s at a temperature in the range of from 40 to 50° C. over a period of at least 48 hours.

A method for producing compressed-gas cylinders is preferred in which the curable epoxy resin matrix has a viscosity in the range of from 300 to 1000 mPa·s, in particular in the range of from 400 to 1000 mPa·s, more preferably in the range of from 300 to 900 mPa·s, even more preferably in the range of from 400 to 900 mPa·s, at a temperature in the range of from 40 to 50° C. over a period of at least 48 hours.

The compressed-gas container according to the invention is intended in particular for storing a pressurised gas. A gas is understood to mean a material which is gaseous under normal conditions, in particular at a normal temperature of 0° C. and a normal pressure of 1.0 bar. In the compressed-gas container itself, the gas can also be in liquid form, for example due to a high pressure or a low temperature.

The gas is in particular hydrogen, natural gas or a liquid gas, in particular propane, propene, butane, butene, isobutane or isobutene or mixtures thereof. The gas is particularly preferably hydrogen or natural gas.

The storage volume of the compressed-gas containers produced according to the invention is in particular from 30 to 9000 l, preferably from 30 to 900 l and more preferably from 30 to 400 l.

The layer thickness of the cured second layer is preferably from 8 to 100 mm, in particular from 8 to 80 mm and in particular 8 to 70 mm.

In particular, the object of the present invention is a method for continuously producing to compressed-gas cylinders which each have a storage volume for a pressurised gas and a sleeve enclosing the storage volume, the sleeve comprising a liner in contact with the storage volume and, at least in regions, at least one second layer deposited on the liner, the method comprising the above-mentioned method steps a) to d), and wherein the curable epoxy resin matrix has a viscosity in the range of from 200 to 1000 mPa·s at a temperature in the range of from 40 to 50° C. over a period of at least 48 hours.

A continuous method which comprises an additional method step in addition to method steps a) to d) is preferred. In this additional method step, the curable epoxy resin matrix is preferably refilled, in particular continuously refilled, in an amount which corresponds to the amount that was removed during the application onto the reinforcing fibres.

Within the meaning of the present invention, the term “curable epoxy resins” means in particular that the epoxy resins used as epoxy resins are those which are thermosettable, i.e. those which, due to their functional groups, specifically epoxy groups, can be polymerised, linked and/or cross-linked and, in particular, can be polymerised, linked and/or cross-linked by heat. In this case, polymerisation, linking and/or cross-linking take place as a result of a polyaddition induced by the curing agent.

According to the invention, the curable epoxy resin matrix comprises at least one epoxy resin. The epoxy resin is preferably a polyether having at least one, preferably at least two, epoxy groups. In a still further preferred embodiment, the curable epoxy resin matrix comprises a curable epoxy resin and additionally a curing agent. Bisphenol-based epoxy resins, in particular bisphenol A diglycidyl ether or bisphenol F diglycidyl ether, novolak epoxy resins, in particular epoxy phenol novolak, or aliphatic epoxy resins are preferably used. A cyanamide-containing curing agent is preferably used as the curing agent.

According to the invention, particularly good results are obtained by using bisphenol A diglycidyl ether or bisphenol F diglycidyl ether as the epoxy resin and/or by using cyanamide as the curing agent.

The epoxy equivalent weight (EEW, hereinafter also referred to as equivalent weight) of an epoxy resin or an epoxy component according to the present invention is determined as a material property of each epoxy resin and indicates the amount of epoxy resin in [g] which has one equivalent [val] of epoxy functions. It is calculated from the molar mass in [g/mol] divided by the functionality fin [val/mol]. The EEW is given as a mean value Ø in [g/eq] or in [g/val]:

ØEEW [g/val]=M [g/mol]/f [val/mol]

If different reactive components are used to formulate the resin, the equivalent weight of a mixture of i epoxy components or of the impregnating resin comprising i epoxy components ØEEWₘᵢₓₜᵤᵣₑ [g/val]) is calculated as follows:

ØEEWₘᵢₓₜᵤᵣₑ [g/val]=mₜₒₜ/(Σmᵢ/ØEEWᵢ)
mₜₒₜ=Σmᵢ where
mᵢ=weights of the individual components of the mixture
ØEEWᵢ=Ø epoxy equivalent weight of component i.

The viscosity describes the toughness of liquids and is measured using an Anton Paar MCR 302 having a CTD 450 viscometer. The curable epoxy resin matrix is subjected to an isothermal viscosity measurement, in which the temperature of the curable epoxy resin matrix in the impregnation bath is selected as the measurement temperature, thus in the range of between 40° C. and 50° C. The corresponding measuring plates of the rheometer are heated to the specific measuring temperature and the curable epoxy resin matrix sample is applied when the temperature is reached. With a measuring gap of 0.052 mm and a rotary shear rate of 5 l/s, the viscosity of the curable epoxy resin matrix is measured at temperatures of 40° C. and 50° C. until the viscosity of 1000 mPa·s has been reached. The viscosity at which the curable epoxy resin matrix reaches 1000 mPa·s serves as the measurement limit at which the time taken to reach the measurement limit represents the comparison between the curable epoxy resin matrix belonging to the method according to the invention and typical amine and anhydride epoxy resin matrices for the method for producing compressed-gas cylinders.

An important point in terms of the method according to the invention for producing a compressed-gas container using the curable epoxy resin matrix is that, due to the property of being liquid over a period of at least 48 hours and having a viscosity in the range of from 200 to 1000 mPa·s, this curable epoxy resin matrix is particularly advantageous for compressed-gas cylinders of larger volumes. These compressed-gas cylinders can take longer to process, with the curable matrix leading to constant wetting of the reinforcing fibres due to the viscosity that remains constant over a long period of time.

Therefore, the object of the present invention is also a method for producing a compressed-gas container, in particular a continuous method for producing a compressed-gas container, which has a storage volume for a pressurised gas and a sleeve enclosing the storage volume, the sleeve comprising a liner in contact with the storage volume and, at least in regions, at least one second layer deposited on the liner, the method comprising the method steps a) to d),

wherein the curable epoxy resin matrix has a viscosity in the range of from 200 to 1000 mPa·s at a temperature in the range of from 40 to 50° C. over a period of at least 48 hours and the deviation in viscosity at a temperature in the range of from 40 to 50° C. over a period of at least 48 hours is at most+/−15%, in particular at most+/−10%, in particular at most+/−8%.

Furthermore, continuous production is possible due to the high latency. Thus, for the first time, it is possible to wind for at least 48 hours using the produced epoxy resin matrix. Since the epoxy resin matrix is continuously consumed in the winding process due to the impregnation of reinforcing fibres, a curable epoxy resin matrix must be refilled for a continuous process. By refilling with fresh, curable epoxy resin matrix, the old matrix in the impregnation bath is thinned and thus the latency of the matrix is extended, i.e. beyond the 48 hours. With the currently commonly used epoxy resin matrices which contain curing agents from the group of amines or anhydrides, refilling or replenishing is only possible to a limited extent. Winding methods using such epoxy resin matrices must be stopped after 4 to 8 hours so that the system can be completely cleaned.

Therefore, the object of the present invention is also a continuous method for producing compressed-gas containers which each have a storage volume for a pressurised gas and a sleeve enclosing the storage volume, the sleeve comprising a liner in contact with the storage volume and, at least in regions, at least one second layer deposited on the liner, the method comprising the following method steps:
a) providing
   i) a liner,
   ii) a curable epoxy resin matrix, and
   iii) reinforcing fibres,
b) applying the curable epoxy resin matrix to the reinforcing fibres, the curable epoxy resin matrix having a temperature in the range of from 15 to 50° C.,
c) winding, laying or depositing the reinforcing fibres on the liner to form the second layer,
d) refilling, in particular continuously refilling, the curable epoxy resin matrix in an amount which corresponds to the amount that was removed during the application onto the reinforcing fibres,
e) curing the second layer at a temperature in the range of from 70 to 140° C.;

wherein the curable epoxy resin matrix has a viscosity in the range of from 200 to 1000 mPa·s at a temperature in the range of from 40 to 50° C. over a period of at least 48 hours.

A continuous method in which method step d) is carried out in such a way that the refill amount is 2 to 8 kg of epoxy resin matrix per hour, in particular 2 to 6 kg of epoxy resin matrix per hour, is preferred.

By controlling the temperature of the impregnation bath and thus the curable epoxy resin matrix to a temperature between 40 to 50° C., the matrix is unaffected by the external temperature influences prevailing in the production spaces. The always constant temperature of the matrix thus leads to a constant, temperature-controlled impregnation viscosity. Due to the constant viscosity and thus the constant impregnation, it is possible to achieve a constant quality in the production of wound compressed-gas containers.

Furthermore, the high latency of the curable epoxy resin matrix offers the possibility of producing a 1C batch (1 component batch) for one or more production days. Thus, for a defined production period, a larger amount of the curable epoxy resin matrix can be premixed, stored at room temperature and removed as required. The production of a large batch also improves the quality compared to a plurality of newly mixed matrices, since the same mixture is always used.

The high latency, the possibility of continuous production and producing a large amount of the curable epoxy resin matrix as a batch for production can result in a reduction in waste curable epoxy resin matrix. The cleaning of the impregnation bath can also be taken into account, in which cleaning agents such as acetone must be used and disposed of in addition to the curable epoxy resin residues. If all aspects are included, it is possible to generate less waste, save on additional costs for cleaning and disposal, and produce said epoxy resin matrix in a more environmentally friendly manner.

It is essential to the invention that the method is carried out in such a way that the curable epoxy resin matrix is applied to the reinforcing fibres at a temperature in the range of from 15 to 50° C. The method can preferably be carried out in such a way that the curable epoxy resin matrix in method step b) has a temperature in the range of from 20 to 50° C., preferably in the range of from 25 to 50° C., preferably in the range of from 30 to 50° C., particularly preferably has a temperature in the range of 40 to 50° C.

As a result, the impregnation viscosity of the matrix in the impregnation bath is adjusted by adjusting the temperature of the curable epoxy resin matrix up to a temperature of 50° C. An impregnation viscosity of from 200 to 1000 mPa·s, in particular from 300 to 900 mPa·s, can be set. In addition, preferred temperatures of the epoxy resin matrix are in the range of 40 to 50° C. higher than the ambient temperatures in the production facilities, and therefore the temperature or the viscosity of the curable epoxy resin matrix remains unaffected and thus a qualitatively constant application onto the reinforcing fibres is made possible by means of a constant impregnation viscosity over a longer production period.

For the method according to the invention for producing a compressed-gas container, an epoxy resin matrix is therefore required which, as a result of the fibre winding process, can easily be applied to the reinforcing fibres by impregnation. A relevant variable for optimal application of the epoxy resin matrix to the reinforcing fibre is impregnation viscosity. This must be adjusted such that the weight ratio of reinforcing fibre to epoxy resin matrix is in the range of from 50:50 to 80:20. As the user knows, these weight ratio ranges are favoured, since insufficient application of the epoxy resin matrix results in a high weight proportion of the reinforcing fibres and, due to the maximum packing density of the reinforcing fibres controlled on the process side, incorrect bonding can occur. Excessive application of the epoxy resin matrix can reduce the packing density of the reinforcing fibres. In both cases, this results in a reduction in the mechanical properties such as the modulus of elasticity or tensile strength of the cured composite component.

According to a further concept, the object of the invention is therefore also a method in which the epoxy resin matrix is applied to the reinforcing fibres in such a way that the second layer has a weight ratio of reinforcing fibre to epoxy resin matrix in the range of from 50:50 to 80:20, preferably in the range of from 60:40 to 80:20.

In order to guarantee optimal application of the epoxy resin matrix to the reinforcing fibres for the method according to the invention and thus also guarantee that the second layer has a weight ratio of reinforcing fibre to epoxy resin matrix in the range of from 50:50 to 80:20, it is necessary that the epoxy resin matrix developed for the method according to the invention has an average EEW value in the range of from 100 to 250 g/eq before curing, so that the epoxy resin matrix has a low molecular weight and is therefore also of low viscosity. In addition to this property that is relevant to the application of the epoxy resin matrix, the curable epoxy resin matrix has an impregnation viscosity of from 300 to 900 mPa·s, in particular from 400 to 800 mPa·s, in particular from 400 to 700 mPa·s, at 40 to 50° C., since it is sufficiently low-viscosity at the temperature for the impregnation of the reinforcing fibre and, at 40 to 50° C., is unaffected by the external temperature influences prevailing in the production spaces. Thus, optimal impregnation of the reinforcing fibres with the epoxy resin matrix used according to the method according to the invention is possible, which leads to a high mechanical performance of the cured compressed-gas container.

It is essential to the invention that the method is carried out in such a way that the epoxy resin matrix has a viscosity of from 200 to 1000 mPa·s at a temperature in the range of from 40 to 50° C. It is preferred here that the epoxy resin matrix has a viscosity of from 300 to 900 mPa·s, in particular from 400 to 800 mPa·s, in particular from 400 to 700 mPa·s, at a temperature in the range of from 40 to 50° C.

The second layer can be cured in a temperature range of from 70 to 110° C. The object of the present invention is therefore also a method in which the second layer is cured at a constant temperature in the range of from 70 to 110° C.

According to the present invention, the method can be carried out particularly advantageously if the curable epoxy resin matrix comprises the following components i) to iii), specifically
i) at least one epoxy resin having at least one epoxy group,
ii) at least one reactive diluent from the group of glycidyl ethers,
iii) at least one curing agent, in particular a liquid curing agent, in particular from the group of cyanamide-containing curing agents.

The curable epoxy resin matrix is primarily composed in such a way that, in addition to providing the properties for fibre-reinforced compressed-gas containers, it also meets the requirements of the method according to the invention for producing the compressed-gas container. Bi-functional epoxy resins and/or epoxy resins having an average EEW value of from 150 to 200 g/eq are preferred here. The cross-linking properties are intended to strengthen the mechanical properties of the compressed-gas container due to the bi-functionality of the epoxy resin, but at the same time be of low viscosity for optimal application onto reinforcing fibres.

The same applies to the reactive diluent which also further dilutes the epoxy resin matrix. A bi-functional glycidyl ether is also selected here in order to do justice to the performance properties of the compressed-gas container.

The liquid cyanamide-containing curing agent is one of the latent liquid curing agents and allows a long processing time for the resin in the curable epoxy resin matrix for the method according to the invention.

The curing profile of the formulations according to the invention can be varied by adding further commercially available additives, as are known to a person skilled in the art for use in this method for processing and curing epoxy resin matrices.

Additives to improve the processability of the uncured epoxy resin compositions or additives to adapt the thermo-mechanical properties of the thermosetting products made therefrom to the requirement profile comprise, for example, fillers, rheological additives such as thixotropic agents or dispersing additives, defoamers, dyes, pigments, toughness modifiers, impact strength improvers or fire protection additives.

With regard to the epoxy resins to be used, all the commercially available products which usually have more than one 1,2-epoxy group (oxirane) and can be saturated or unsaturated, aliphatic, cycloaliphatic, aromatic or heterocyclic can be used. In addition, the epoxy resins can have substituents such as halogens, phosphorus groups and hydroxyl groups. Epoxy resins based on glycidyl polyethers of 2,2-bis(4-hydroxyphenyl) propane (bisphenol A) and the bromine-substituted derivative (tetrabromobisphenol A), glycidyl polyethers of 2,2-bis(4-hydroxyphenyl)methane (bisphenol F) and glycidyl polyethers of novolaks and epoxy resins based on aniline or substituted anilines such as p-aminophenol or 4,4′-diaminodiphenylmethanes are particularly preferred. Epoxy resins based on glycidyl polyethers of 2,2-bis(4-hydroxyphenyl) propane (bisphenol A) and epoxy resins based on glycidyl polyethers of 2,2-bis(4-hydroxyphenyl)methane (bisphenol F) are very particularly preferred. Such epoxy resins can be cured particularly well by using the curing agent composition preferred herein. With regard to the method according to the invention, one or combinations of the listed resins in combination with a reactive diluent and a curing agent are intended to preferably form an epoxy resin matrix which has an average EEW value in the range of from 100 to 250 g/eq.

According to the present invention, epoxy resins which can be referred to as “low-viscous modified bisphenol A” can very particularly preferably be used. These epoxy resins have a dynamic viscosity of from 4000 to 6000 mPa·s at room temperature (25° C.). Thus, epoxy resins based on glycidyl polyethers of 2,2-bis(4-hydroxyphenyl) propane (bisphenol A) and epoxy resins based on glycidyl polyethers of 2,2-bis(4-hydroxyphenyl)methane (bisphenol F) which have a dynamic viscosity of from 4000 to 6000 mPa·s at room temperature (25° C.) can more preferably be used. Epoxy resins based on glycidyl polyethers of 2,2-bis(4-hydroxyphenyl) propane (bisphenol A) and epoxy resins based on glycidyl polyethers of 2,2-bis(4-hydroxyphenyl)methane (bisphenol F) which have a dynamic viscosity of from 4000 to 6000 mPa·s at room temperature (25° C.) and have an average EEW value in the range of from 100 to 250 g/eq, in particular in the range of from 100 to 210 g/eq, in particular in the range of from 100 to 190 g/eq, can very particularly preferably be used.

Thus, in the method according to the invention, a curable epoxy resin matrix which, before curing, has an average EEW value in the range of from 100 to 250 g/eq can particularly preferably be used.

Furthermore, in the method according to the invention, a curable epoxy resin matrix which comprises an epoxy resin from the group of bi-functional epoxy resins and/or comprises an epoxy resin, in particular a bi-functional epoxy resin, which has an average EEW value of from 150 to 200 g/eq can particularly preferably be used.

Furthermore, in the method according to the invention, a curable epoxy resin matrix which comprises a reactive diluent selected from the group of bi-functional glycidyl ethers and/or comprises a glycidyl ether, in particular a bi-functional glycidyl ether which has an average EEW value of from 100 to 200 g/eq, can particularly preferably be used.

According to a particularly preferred embodiment of the method, the epoxy resin matrix comprises a curing agent, in particular a liquid curing agent, which contains cyanamide (CAS 420-04-2; NC—NH₂) in its composition. The mode of action of these curing agents, in particular liquid curing agents, in the epoxy resin is comparable to the curing properties of dicyandiamide accelerated with imidazoles. In contrast to epoxy resin compositions which contain typical amine curing agents, however, a latency of a plurality of days is retained at room temperature. In addition, polymer resins cured with the cyanamide-based liquid curing agent can be provided which have high glass transition temperatures in comparison with polymer resins cured with amine curing agents.

Overall, a curing agent or a curing agent composition, in particular a liquid curing agent, can therefore be made available which, due to the high latency in the polymer resin compositions and the high reactivity in the polymer resin compositions at the curing temperature, is extremely suitable for use in the method according to the invention for producing a compressed-gas cylinder by means of fibre winding.

Glycidyl ethers, in particular, can be used as reactive diluents in the method according to the invention or in the epoxy resin matrix. Furthermore, mono-functional, bi-functional and poly-functional glycidyl ethers can preferably be used. In particular, glycidyl ethers, diglycidyl ethers, triglycidyl ethers, polyglycidyl ethers and multiglycidyl ethers and combinations thereof should be mentioned here. Glycidyl ethers from the group comprising 1,4-butanediol diglycidyl ethers, trimethylolpropane triglycidyl ethers, 1,6-hexanediol diglycidyl ethers, cyclohexanedimethanol diglycidyl ethers, C₈-C₁₀ alcohol glycidyl ethers, C₁₂-C₁₄ alcohol glycidyl ethers, cresol glycidyl ethers, poly(tetramethylene oxide) diglycidyl ethers. 2-ethylhexyl glycidyl ethers, polyoxypropylene glycol diglycidyl ethers, polyoxypropylene glycol triglycidyl ethers, neopentyl glycol diglycidyl ethers, p-tert-butylphenol glycidyl ethers, polyglycerol multiglycidyl ethers and combinations thereof can be particularly preferably used.

Very particularly preferred glycidyl ethers are 1,4-butanediol diglycidyl ethers, trimethylolpropane triglycidyl ethers, neopentyl glycol diglycidyl ethers, 1,6-hexanedial diglycidyl ethers, cyclohexanedimethanol diglycidyl ethers and combinations thereof.

These reactive diluents can be used to adjust the viscosity of the epoxy resin. Here, mono-functional glycidyl ethers can react with the epoxy resin without cross-linking. Therefore, at least one bi-functional glycidyl ether, a diglycidyl ether, is used for the method according to the invention in order to adjust the impregnation viscosity. This is intended to help ensure that cross-linking of the curable epoxy resin matrix is also possible in order to achieve good mechanical properties for the compressed-gas container. In addition, the diglycidyl ether preferably has an average EEW value of from 100 to 200 g/eq and thus has a small molecular weight, as a result of which it has a lower viscosity in comparison with diglycidyl ethers having a higher EEW.

With regard to the selection of the reinforcing fibres to be used, reinforcing fibres selected from the group of carbon fibres, glass fibres, aramid fibres and basalt fibres can be used in the method described herein.

These reinforcing fibres can more preferably be provided or used in the form of filaments, threads, yarns, woven fabrics, braided fabrics or knitted fabrics.

Furthermore, reinforcing fibres made of silicon carbide, aluminium oxide, graphite, tungsten carbide or boron can also be selected. Furthermore, reinforcing fibres can also be selected from the group of natural fibres such as seed fibres (e.g. kapok, cotton), bast fibres (e.g. bamboo, hemp, kenaf, flax), and leaf fibres (such as henequen, abaca). Combinations of the fibres can also be used for the method according to the invention.

Of the reinforcing fibres mentioned, glass fibres and carbon fibres, in particular in the form of filaments, threads or yarns, are preferred. These reinforcing fibres have particularly good mechanical properties, in particular high tensile strength.

As mentioned at the beginning, the choice of liners depends on the type of compressed-gas container to be produced. Thus, both thermoplastics liners, in particular liners made of HD polyethylene or polyamide, and also metal liners, in particular liners made of aluminium or steel, can be used in the method according to the invention. The liner can also be viewed as the first layer on which, according to the invention, the second layer comprising the epoxy resin matrix and reinforcing fibres is deposited.

The present invention is explained in more detail below with reference to drawings and associated examples. In the drawings:

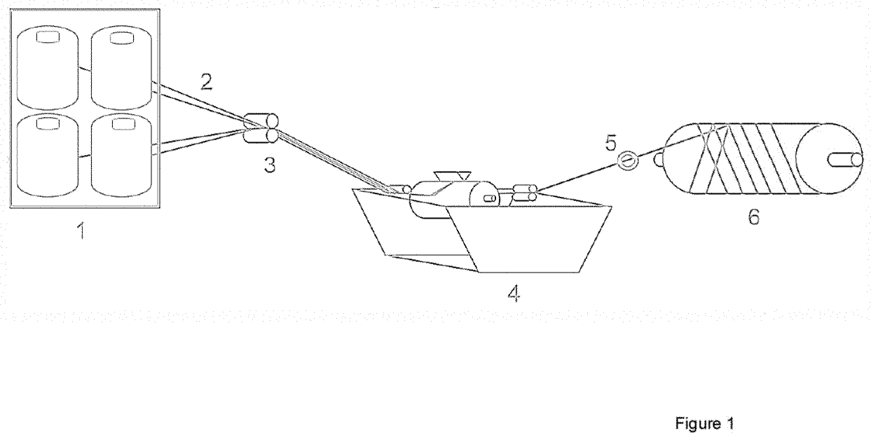

FIG. 1: is a simple schematic view of the fibre winding process for producing a compressed-gas container according to the present invention.

In FIG. 1, a winding system for producing a compressed-gas container is shown schematically. Starting from the spool stand system (1), the reinforcing fibres (2) are drawn via a reinforcing fibre guide (3) to the heatable impregnation bath (4) using an impregnation roller, resin scraper and reinforcing fibre guide. The tension of the reinforcing fibres through the impregnation bath (4) is generated by the rotation of the clamping device together with the liner (6), to which the reinforcing fibre bundles were fixed at the beginning of the process. As a result of the tension, the reinforcing fibres on the impregnation roller are wetted with the curable epoxy resin matrix, excess resin is wiped off using the resin scraper and a reinforcing fibre guide is pulled in the direction of the outlet head (5). The outlet head (5) controls the placement of the reinforcing fibres on the liner (6).

The following examples of the method were carried out using a system corresponding to this basic arrangement.

### EXAMPLES

### 1) Curable Epoxy Resin Matrices

a) Raw Materials Used
Component (A) Product name: DYHARD® RF2100 (AlzChem Trostberg GmbH) Modified, bi-functional bisphenol A epoxy resin (EEW=170-190 g/eq) (viscosity at 25° C.=4000-6000 mPa·s)
Component (B) Product name: DYHARD® Fluid 212 (AlzChem Trostberg GmbH) Cyanamide-based liquid curing agent (viscosity at 25° C.=80-160 mPa·s)
Component (C) Product name: EPON RESIN 828 (Hexion Inc.) Unmodified bisphenol A epoxy resin (EEW=185-192 g/eq) (viscosity at 25° C.=11-16 Pa·s)
Component (D) Product name: Jeffamine® T-403 (Huntsman Cooperation) Amine liquid curing agent (viscosity at 25° C.=72 mPa·s)
Component (E) Product name: Araldite® LY 1564 SP (Huntsman Cooperation) Formulated, bisphenol A-based epoxy resin (epoxy content=5.8-6.05 eq/kg) (viscosity at 25° C.=1200-1400 mPa·s)
Component (F) Product name: Aradur® 917 (Huntsman Cooperation) Anhydride liquid curing agent (viscosity at 25° C.=50-100 mPa·s)
Component (G) Product name: DMP-30™ (Sigma-Aldrich Chemie GmbH) Accelerator: 2,4,6-tris(dimethylaminomethyl)phenol
Component (H) Product name: Araldite® LY 1556 SP (Huntsman Cooperation) Bisphenol A-based epoxy resin (epoxy content=5.30-5.45 eq/kg) (viscosity at 25° C.=10-12 Pa·s)
Component (I) Product name: 1-methylmidazole (Carl Roth GmbH & Co KG) Accelerator

b) Production of the Matrices

The liquid curing agents (components B, D, F) are added to the particular epoxy resins (components A, C, E, H) and, in the case of anhydride liquid curing agents (component F), the particular accelerators (component G or I) are added, and stirred until homogeneous. In each case, 100 g of the formulation is then removed for gel time measurements. At the same time, the isothermal viscosity is measured on the viscometer. A small proportion of the mixture is removed for the measurements on the DSC. For the winding process, the curable epoxy resin matrix produced in each case is heated to 40° C. and placed in the temperature-controlled impregnation bath. The fibre winding process begins when the temperature remains constant.

TABLE 1
Composition of curable epoxy resin matrix 1 according to the invention
and comparison matrices 2, 3 and 4

| Composition | Matrix 1 | Matrix 2 | Matrix 3 | Matrix 4 |
|---|---|---|---|---|
| Component A | 100 | — | — | — |
| Component B | 10 | — | — | — |
| Component C | — | 100 | — | — |
| Component D | — | 43 | — | — |
| Component E | — | — | 100 | — |
| Component F | — | — | 98 | 90 |
| Component G | — | — | 3 | — |
| Component H | — | — | — | 100 |
| Component I | | | | 1 |

c) Test Regulations for Checking the Material Properties

DSC:

Mettler Toledo DSC 1

Dynamic DSC:

A sample of the formulation is heated from 30 to 250° C. at a heating rate of 10 K/min. The exothermic reaction peak is evaluated by determining the onset temperature (T_{Onset}), the temperature at the peak maximum (T_{Max}) and the peak area as a measure of the heat of reaction released (Δ_{R}H).

Isothermal DSC:

A sample of the formulation is kept constant at the specified temperature for the specified to time (isothermal curing of the formulation). The evaluation is carried out by determining the time of the peak maximum (as a measure for the start of the curing process) and of 90% conversion (as a measure for the end of the curing process) of the exothermic reaction peak.

Rheometer:

Anton Paar MCR 302 with CTD 450

Isothermal Viscosity:

The isothermal viscosity curve of a sample at 40° C. and 50° C. is determined on the Anton Paar viscometer MCR302 with the measuring system D-PP25 (1° measuring cone) at a measuring gap of 0.052 mm. When the preset temperature is reached in the measuring chamber of the viscometer, the measuring sample is applied to the measuring plate. The default setting for recording measuring points was set to continuous recording of 1 or 0.5 measuring points per minute.

It is measured in rotation at a shear rate of 5 l/s. The measuring cone is moved to the preset measuring gap height of 0.052 mm and the measurement is started.

After completion of the measurement, the measurement curve is evaluated using the data recording in the Rheoplus software, version 3.62, and the time taken to reach the viscosity of 1000 mPa·s is taken from the data recording.

Gel Time Test:

Exactly 100 g of each formulation were produced in one go and then immediately placed in a drying cabinet at 40° C. and 50° C. The formulation was stirred and checked every hour. If the mixture could no longer be stirred homogeneously, the time was documented as gel time and the sample was classified as no longer liquid.

### Example 1 (According to the Invention)

10 parts by weight of component (B) are added to 100 parts by weight of component (A) and the mixture is stirred until homogeneous. In each case, 100 g of the formulation is then removed for gel time measurements. At the same time, the isothermal viscosity is measured on the viscometer. A small proportion of the mixture is removed for the measurements on the DSC.

TABLE 2
Epoxy resin compositions including test results (material parameters)

| Parameters | Matrix 1 | Matrix 2 | Matrix 3 | Matrix 4 |
|---|---|---|---|---|
| Dynamic DSC-onset [° C.] | 144 | 88 | 113 | 120 |
| Dynamic DSC-peak [° C.] | 152 | 132 | 138 | 152 |
| Dynamic DSC-enthalpy [J/g] | 243 | 548 | 319 | 420 |
| Isothermal DSC at 100° C. | 237 | 50 | 35 | 62 |
| Time to 90% conversion [min] | | | | |
| Gel time manually at 40° C. [h] | >240 | 3.0 | 22 | 40 |
| (100 g formulation) | | | | |
| Gel time manually at 50° C. [h] | 144 | 1.5 | 7.5 | 14 |
| (100 g formulation) | | | | |
| Isothermal viscosity at 40° C. [h] * | 59 | 1.0 | 6.4 | 8.2 |
| Isothermal viscosity at 50° C. [h] * | 95 | 0.9 | 3.4 | 6.2 |
| Starting viscosity at 40° C. [mPa*s] | 585 | 443 | 150 | 204 |
| Starting viscosity at 45° C. [mPa*s] | 388 | 314 | 100 | 150 |
| Starting viscosity at 50° C. [mPa*s] | 242 | 202 | 90 | 106 |

* Pot life measurement via rheometer; time to reach viscosity of 1000 mPa*s.

Table 2 shows that, from the isothermal viscosity measurements and the determination of the initial viscosities from the isothermal measurement series of matrices 1-4, matrix 1 achieves high pot life values, at both 40° C. and 50° C., of 59 h at 40° C. and 95 h at 50° C. and thus has a viscosity range of from 200 to 1000 mPa·s over 48 h. The manual gel time test of matrices 1-4 also shows that matrix 1 is liquid for well over 48 h at both temperatures and thus hardens from 144 h at 50° C. and over 240 h at 40° C. These comparisons therefore show a longer pot life and therefore also a higher latency of matrix 1 compared to the comparison matrices 2-4.

This means that the matrix system 1, due to the high latency, advantageously meets the requirements for compressed-gas cylinders, including those with larger volumes. Longer processing times with reduced cleaning stops and disposal residues are possible and the constant, low viscosity over the winding time can lead to constant wetting of the reinforcing fibres.

### 2) Examples of Liners—Manufacturer Certificates

An HDPE (PE-HD; high density polyethylene) liner having a capacity of 51 litres, a total length of 882 mm, a diameter of 314.5 mm and a weight of 8.9 kg (including boss parts) was used to for the experiment.

### 3) Examples of Reinforcing Fibres—Manufacturer Certificates

Carbon fibre: Mitsubishi Rayon MRC_37_800 WD_30 K Manufacturer: Mitsubishi Chemical Carbon Fiber and Composite, Inc.

### 4) Examples of Methods for Producing Compressed-Gas Containers

a) General Procedural Regulation—Possibly with Reference to the Drawings

Using the Composicad software, a winding structure of the carbon fibre was calculated, which is designed for a theoretical burst pressure of 460 bar. Our series of experiments is based on a cylinder designed for 200 bar. The standard requires a safety factor of 2.3 of the operating pressure for this type of pressure container, so therefore a minimum burst pressure of 460 bar. At the beginning, the HDPE liner is fastened in the clamping device to the winding machine at both ends, cleaned with acetone and activated using a Bunsen burner on the outside with a small flame. For the formulation, 100 parts of component A are stirred together with 10 parts of component B until homogeneous and heated to 40° C. Then the formulation is put into the temperature-controlled impregnation bath.

The impregnation bath is heated to 40° C. to set the optimum impregnation viscosity. The outside temperature during winding was 15.9° C. The scraper blade was set to a gap of 0.6 mm. The reinforcing fibres from the 8 spools are pulled through the bath to the liner and brought together on the component to form a strip approximately 2.7 cm wide. The winding process takes 35 minutes. The winding takes place axially and radially around the liner according to the calculations and adjustments in the program. In order to fix the end of the reinforcing fibre, it is placed under the penultimate winding as a loop and protruding fibres are cut off. The curing took place at 95° C. for 8 hours. The cylinder was hung horizontally in the furnace and rotated while being cured.

b) Test Regulations

Burst test according to ISO11439

Pressure cycle test according to ISO11439 and NGV02

c) Test Results

The cured cylinder has a weight of 17.70 kg. The diameter is 330 mm. A total of 5.494 kg of carbon fibre was used for the winding. Thus, the amount of formulation is 3.306 kg.

Burst test: Maximator Manometer analog 0-2500 bar (serial number 247298001), GS 4200 USB pressure transducer (serial number 510305)

TABLE 3
Achieved burst pressure and fibre tension and performances
calculated therefrom

| | |
|---|---|
| Burst pressure [bar] | 519 |
| Achieved fibre tension [MPa] | 3000 |
| Container performance | 1495.4 |
| Laminate performance | 3007.8 |

$$Container performance : \frac{( burst pressure \times cylinder volume )}{Cured cylinder weight} \times 1000$$

$$Laminate performance : \frac{( burst pressure \times cylinder volume )}{Cured laminate weight} \times 1000$$

Pressure cycle test: Galiso Manometer analog 0-11,000 PSI (serial number 508130013)

TABLE 4
Results obtained from the pressure cycle test at room temperature.

| | |
|---|---|
| Number of cycles (cycles) | 61432 |
| Number of valid cycles (cycles) | 61372 |
| Max. temperature [° C.] | 39.4 |
| Average cycle rate (cycles/min) | 9.1 |
| Average pressure min. [bar] | 2.7 |

After the test, the cylinder was inspected and showed no external defects. When cut in half, a small crack could only be found in the HDPE liner after 61432 cycles. The laminate remained undamaged.

1. Method for producing a compressed-gas container which has a storage volume for a pressurised gas and a sleeve enclosing the storage volume, the sleeve comprising a liner in contact with the storage volume and, at least in regions, at least one second layer deposited on the liner, the method comprising the following method steps:
a) providing
i) a liner,
ii) a curable epoxy resin matrix, and
iii) reinforcing fibres,
b) applying the curable epoxy resin matrix to the reinforcing fibres, the curable epoxy resin matrix having a temperature in the range of from 15 to 50° C.,
c) winding, laying or depositing the reinforcing fibres on the liner to form the second layer,
d) curing the second layer at a temperature in the range of from 70 to 140° C., wherein the curable epoxy resin matrix has a viscosity in the range of from 200 to 1000 mPa·s at a temperature in the range of from 40 to 50° C. over a period of at least 48 hours.

2. Method according to claim 1, wherein the curable epoxy resin matrix in method step b) has a temperature in the range of from 20 to 50° C.

3. Method according to claim 1, wherein the epoxy resin matrix is applied to the reinforcing fibres in such a way that the second layer has a weight ratio of reinforcing fibre to epoxy resin matrix in the range of from 50:50 to 80:20.

4. Method according to claim 1, wherein the epoxy resin matrix has a viscosity of from 300 to 900 mPa·s at a temperature in the range of from 40 to 50° C.

5. Method according to claim 1, wherein the second layer is cured at a temperature in the range of from 70 to 120° C.

6. Method according to claim 1, wherein the epoxy resin matrix comprises:
i) at least one epoxy resin having at least one epoxy group,
ii) at least one reactive diluent from the group of glycidyl ethers,
iii) at least one curing agent.

7. Method according to claim 1, wherein the epoxy resin matrix has an average EEW value in the range of from 100 to 250 g/eq before being cured.

8. Method according to claim 6, wherein the epoxy resin is selected from the group of bi-functional epoxy resins and/or in that the epoxy resin has an average EEW value of from 150 to 200 g/eq.

9. Method according to claim 7, wherein the reactive diluent is selected from the group of bi-functional glycidyl ethers and/or in that the glycidyl ether has an average EEW value of from 100 to 200 g/eq.

10. Method according to claim 1, wherein the reinforcing fibres are selected from the group consisting of carbon fibres, glass fibres, aramid fibres and basalt fibres.

11. Method according to claim 1, wherein the reinforcing fibres are provided in the form of filaments, threads, yarns, woven fabrics, braided fabrics or knitted fabrics.

12. Method according to claim 1, wherein the liner is a thermoplastics liner or a metal liner.

13. Method according to claim 1, wherein the curable epoxy resin matrix in method step b) has a temperature in the range of from 25 to 50° C.

14. Method according to claim 1, wherein the curable epoxy resin matrix in method step b) has a temperature in the range of from 30 to 50° C.

15. Method according to claim 1, wherein the curable epoxy resin matrix in method step b) has a temperature in the range of from 40 to 50° C.

16. Method according to claim 6, wherein the at least one curing agent is a liquid curing agent.

17. Method according to claim 16, wherein at least one curing agent is a cyanamide-containing curing agent.

18. Method according to claim 1, wherein the epoxy resin matrix has a viscosity of from 400 to 800 mPa·s at a temperature in the range of from 40 to 50° C.

19. Method according to claim 1, wherein the epoxy resin matrix has a viscosity of from 400 to 700 mPa·s at a temperature in the range of from 40 to 50° C.
